(19) United States
(12) Patent Application Publication
(10) Pub. No.: US 2009/0291643 A1
(43) Pub. Date: Nov. 26, 2009

(54) METHOD AND SYSTEM FOR MEASURING NOISE SIGNAL

(75) Inventor: Chu-Hsin Tsao, Hsinchu (TW)

Correspondence Address: EDWARDS ANGELL PALMER & DODGE LLP, P.O. BOX 55874, BOSTON, MA, 02205, US

(73) Assignee: RALINK TECHNOLOGY CORPORATION, Hsinchu (TW)

(21) Appl. No.: 12/465,811

(22) Filed: May 14, 2009

(30) Foreign Application Priority Data
May 22, 2008 (TW) 097118859

(51) Int. Cl. H04B 17/00

(52) U.S. Cl. 455/67.13

(57) ABSTRACT

A method and system for measuring noise signals are provided. The method includes configuring a receiving band of a wireless network signal receiving device and enlarging a receiving range of the wireless network signal receiving device to the maximum; sampling and/or analyzing signals received so as to obtain noise signal data, so as to debug and improve a wireless network equipment without a detecting device.

### BACKGROUND OF THE INVENTION

1. Field of the Invention

The present invention relates to a method and system for measuring noise signals.

2. Description of Related Art

As the Internet technology develops at a tremendous speed, it has so far become the most economical transmission medium that covers the widest area. In addition, as people are becoming more and more dependent on the Internet, the convenience of it is also becoming more important. Because the general network system is usually wired, and the wired network is inconvenient in terms of hardware installation and location limitation, wireless network is then developed to overcome the drawbacks of the wired network system.

Wireless network utilizes radio waves to transmit data. The most major difference between the wireless network and the wired network is the transmission medium, whereby one uses radio waves and another one uses physical wires. As wireless network transmits data via radio waves, thus the hardware, in terms of its mobility, is a lot more convenient than the wired network.

There are a variety of wireless techniques, such as bluetooth wireless transmission system, global system for mobile communications (GSM), general packet radio service (GPRS) or WiMAX. However, in general, wireless network refers to wireless local area network (WLAN), i.e. IEEE 802.11 standards developed by the IEEE LAN/MAN Standards Committee.

Unlike wired network equipments, a wireless network equipment is convenient in terms of installation and mobility. On the other hand, the wireless network is also easily affected by the external environment or the noise signals generated by the system itself, thereby affecting the overall effectiveness and stability of the wireless network equipments. In order to eliminate noise signal interference, noise signal measuring instrument (spectrum analyzer) must be used first to scan the channels of the wireless network, thereby performing subsequent noise signal elimination and improvement after obtaining the strength of noise signals.

However, operation of such noise signal measuring instruments requires more professional knowledge, and the instruments are inconvenient in terms of their mobility. To operators who require initial verification or quick testing, using noise signal measuring instrument to measure noise signal is an inconvenient, time-consuming and high cost method. On the other hand, to those without sufficient professional knowledge in instruments, it is definitely difficult for them to implement the noise signal confirmation.

Accordingly, it is an urgent issue in the field to provide a convenient and cost-effective method and system for measuring noise signals.

### SUMMARY OF THE INVENTION

In order to solve the drawbacks of the aforementioned conventional technique, the present invention provides a method for measuring noise signals applicable to an information processing device connected to a wireless network system. The method includes: configuring the receiving band of the wireless network signal receiving device; enlarging the receiving range of the wireless network signal receiving device to the maximum; receiving signals having the WLAN signals for data transmission and the noise signals by the wireless network signal receiving device; and sampling and/or analyzing the received signals to obtain the noise signal data.

In one embodiment, the step of sampling and/or analyzing the received signals further includes outputting the noise signal data to a display device.

In one embodiment, the display device is one of a display and a printer.

In one embodiment, the receiving band of the wireless network signal receiving device includes a plurality of channels, and after the step of sampling and/or analyzing the received signals, the method includes shifting to the next channel and returning to the step of enlarging the receiving range.

In an embodiment of the present invention, in the step of the step of sampling and/or analyzing the received signals, a specific number of noise signal data are obtained at a specific sampling rate. Preferably, the step of sampling and/or analyzing the received signals includes calculating an average of the specific number of noise signal data. More preferably, the step of sampling and/or analyzing the received signals includes: arranging the specific number of noise signal data in a sequence with an increasing order, eliminating a portion of noise signal data from either the beginning or the end of the sequence, and calculating the average of the remaining noise signal data.

The present invention further provides a system for measuring a noise signal, including: a signal receiving module for receiving signals having WLAN signals for data transmission and noise signals; a data processing device for controlling the operation of the signal receiving module device, wherein the data processing device includes: a channel configuration unit for configuring the receiving channels of the signal receiving module; a receiving range configuration unit for configuring the receiving range of the signal receiving module; and a data processing unit performing data for sampling and/or analyzing data on signals received by the signal receiving module, wherein the receiving range configuration unit enlarges the receiving range of the wireless network signal receiving device to the maximum, and the data processing unit then obtains the noise signal data by applying data sampling and/or data analysis to the received noise signals.

In comparison to the conventional technique, the method and system for measuring a noise signal according to the present invention provides engineers or R&D staffs in the field of wireless networks with a better solution of noise signal measurement. By using the method of the present invention, other noise signal measuring equipment or instrument are not required and the wireless network signal receiving device of the product can measure the external noise signal or its own noise source. Hence, the present invention provides a fast, convenient and low-cost noise signal measuring method and system, such that the operators can immediately perform product debugging and calibration, thereby providing a fast technical support. In addition, the manufacturing time of the product is also relatively shortened and the economic efficiency of the product is improved.

### BRIEF DESCRIPTION OF DRAWINGS

FIG. 1 is a diagram illustrating a method for measuring a noise signal according to the present invention;

FIG. 2 is a diagram illustrating a method for measuring a noise signal according to a preferred embodiment of the present invention;

FIG. 3 is a diagram illustrating a method for measuring a noise signal according to a preferred embodiment of the present invention;

FIG. 4 is a block diagram showing a system for measuring a signal noise according to the present invention; and

FIG. 5 is a diagram illustrating a system for measuring a signal noise according to a preferred embodiment of the present invention.

### DETAILED DESCRIPTION OF PREFERRED EMBODIMENTS

The following illustrative embodiments are provided to illustrate the disclosure of the present invention, these and other advantages and effects can be apparently understood by those in the art after reading the disclosure of this specification. The present invention can also be performed or applied by other different embodiments.

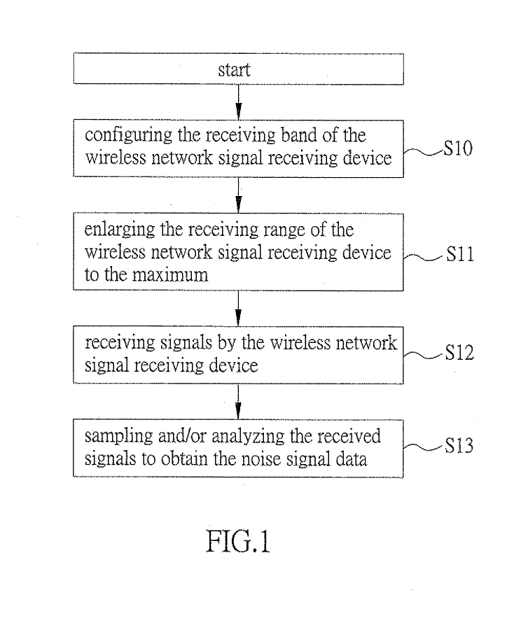

Referring to FIG. 1, a flowchart illustrating a method for measuring noise signals according to the present invention is shown. As shown in FIG. 1, the method for measuring noise signals includes the following steps.

At step S10, in accordance with the wireless network standard, channels are selected for the noise signal measurement and the receiving band of the wireless network signal receiving device is configured. IEEE 802.11b/g are standards for wireless local area network developed by the IEEE LAN/MAN Standards Committee in the 5 GHz and 2.4 GHz public spectrum bands. The standard utilizes 14 channels with channel 1 centered at 2412 MHz, channel 2 centered at 2417 MHz, channel 3 centered at 2422 MHz, . . . and etc. At this step, measurement can be done on one of the aforementioned channels. The wireless network signal receiving device may be LAN card, on-board wireless network chipset or antenna. In addition, wireless network signal receiving device is applicable to wireless network system such as wireless LAN (WLAN), Bluetooth wireless transmission system, global system for mobile communications, general packet radio service or WiMAX. In other embodiments, the wireless network signal receiving device is also applicable to 802.11a WLAN in the 5 GHz public spectrum band.

At step S11, the receiving range of the wireless network signal receiving device is enlarged to the maximum, and channels on which the signal is received and the signal type are not limited. In order to effectively receive WLAN signals, wireless network signal receiving device, verifies the strength of transmitted signals and channel stability, thereby imposing certain limitations on the wireless signal receiving range. In the present embodiment, since the strength of the noise signal is usually lower than the strength of the WLAN signals that are used to transmit data, the receiving range of the wireless network signal receiving device is enlarged to the maximum for receiving the noise signal.

At step S12, the wireless network signal receiving device is allowed to receive signals. As mentioned above, the received signals include WLAN signals for data transmission and noise signals.

At step S13, sampling and/or analysis of the received signals are performed to obtain the noise signal data. Since signals received by the wireless network signal receiving device are not only noise signals, data sampling and/or signal analysis are performed to obtain WLAN signalsp for data transmission and noise signal data. Data sampling and/or signal analysis can be optionally adjusted.

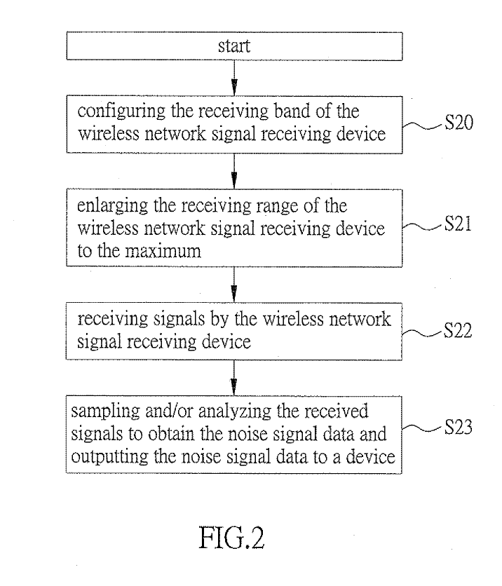

Referring to FIG. 2, a method for measuring noise signals according to a preferred embodiment of the present invention is illustrated.

At step S23, the obtained noise signal data are sent to a display device. The display device can be oscilloscopes displaying the output of the noise signal data, or printers connected to the display device, thereby facilitating the analysis of noise signals and determining the effects of the noise signals.

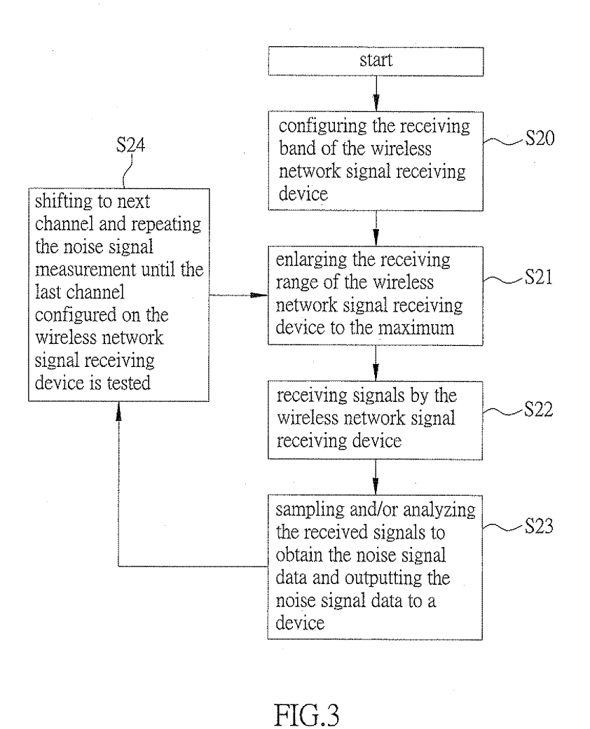

Referring to FIG. 3, a method for measuring the noise signal according to a preferred embodiment of the present invention is illustrated.

At step S24, the receiving channel is shifted to another channel and the noise signal measurement process is repeated starting from step S21. The noise signal measurement process is performed repeatedly on all default channels on the wireless network signal receiving device. For example, in the 802.11b/g standard, channel 1 (2412 MHz) is configured as a testing channel. After the test on channel 1 is done, test is then shifted to be performed on channel 2 (2417 MHz). The test is performed in this way until the 14th channel or the last channel (2484 MHz) is tested. In this way, the noise signal data on all channels in the 2.4-GHz system are obtained.

In the embodiment, receiving channels of the wireless network signal receiving device are configured first. One of the channels is selected for the measurement and then the receiving range of the wireless network signal receiving device is enlarged to the maximum. Subsequently, the wireless network signal receiving device is allowed to receive signals and sampling and/or analysis of the WLAN signals for data transmission as well as the noise signals are then performed to obtain the noise signal data. After that, noise signal data analyzed are then sent to a display device or a printing device for output. The receiving channel can be selectively shifted to the next channel for the noise signal measurement until all channels of the spectrum are tested.

In an embodiment, the step of sampling signals is implemented at a specific sampling rate to obtain a specific number of noise signal data. In another example, the step of analyzing signals involves calculating an average of the specific number of noise signal data.

More particularly, the step of analyzing data includes arranging the specific number of noise signal data in a sequence with an increasing order, eliminating a portion of noise signal data from either the beginning or the end of the sequence, and calculating the average of the remaining noise signal data. For example, in FIG. 3, excessive samples will increase the test duration and insufficient samples will cause errors which result in a deviation of the actual data, and thus 10 sets of data, −95 dBm, −70 dBm, −100 dBm, −93 dBm, −80 dBm, −94 dBm, −94 dBm, −93 dBm, −92 dBm and −93 dBm, are sampled first. The 10 sets of data are rearranged in an increasing order, i.e. −70 dBm, −80 dBm, −92 dBm, −93 dBm, −93 dBm, −93 dBm, −94 dBm, −94 dBm, −95 dBm, and −100 dBm. Since the sampled data may include erroneously triggered data and abnormal interference, the first and the last three sets are deleted, leaving −93 dBm, −93 dBm, −93 dBm, and −94 dBm, for average calculation. It is then obtained that the strength of the noise signal is approximately −93 dBm.

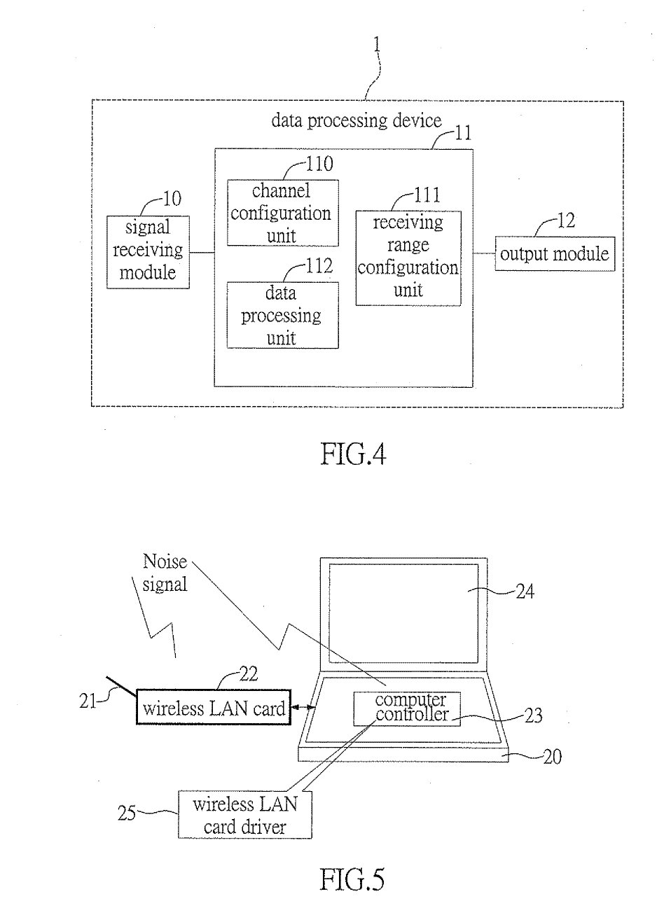

Referring to FIG. 4, a block diagram showing the system for measuring noise signals according to the present invention is illustrated. As shown in FIG. 4, the wireless network system 1 for measuring noise signals includes a signal receiving module 10, and a data processing device 11. The data processing device 11 includes a channel configuration unit 110, a receiving range configuration unit 111 and a data processing unit 112.

The signal receiving module 10 receives WLAN signals for data transmission and noise signals. In contrast, the conventional wireless network signal receiving module only receives WLAN signals for data transmission. The signal receiving module 10 can be a wireless signal receiving device, such as wireless LAN card, antenna, and/or RF transceivers.

The data processing device 11 controls the operation of the signal receiving module 10. The signal receiving module 10 must execute the signal receiving operation according to different circumstances, thus signal receiving module 10 must be controlled and configured by the processing device 11. The data information processing device 11 can be, but not limited to a personal computer, notebook, server, workstation, cell phone, PDA and other devices with data processing function. Noise signal measurement is then performed with the aforementioned wireless LAN card, antenna and/or RF transceiver.

The channel configuration unit 110 serves to configure the receiving channels of the signal receiving module 10. Due to differences in the receiving range in different bands as defined in the communication standard of the wireless network system, the channel configuration unit 110 must select a specific band to receive noise signals according to the specific wireless network communications standard. As mentioned above, IEEE 802.11b/g uses 2.4 XGHz spectrum band, and IEEE 802.11a uses 5.X spectrum band.

The receiving range configuration unit 111 serves to configure the receiving range of the signal receiving module 10. Specifically, the receiving range configuration unit 111 configures the receiving signal strength for the signal receiving module 10 and enlarges the signal receiving range to the maximum. As mentioned above, in the present embodiment, since the strength of the noise signal is lower, and is usually lower than the WLAN signals for data transmission, the receiving range of the signal receiving module 10 is enlarged to the maximum to receive the noise signals.

The data processing unit 112 performs data sampling and/or data analysis on the signals received by the signal receiving module 10, wherein the received signals include the noise signals and the WLAN signals for data transmission. For example, the data processing unit 112 is a baseband processor. The signals received by the signal receiving module 10 are not all noise signals, and thus noise signal data can only be obtained by certain process on the received signals having the WLAN signals for data transmission and the noise signals.

The channel configuration unit 110 configures the receiving channels of the signal receiving module 10. The receiving range configuration unit 111 enlarges the receiving range of the signal receiving module 10 to the maximum, thereby allowing the data processing device 11 to control the signal receiving module 10 which in turn receives signals having the WLAN signals for data transmission and the noise signals. Subsequently, the data processing unit 112 then performs data sampling and/or data analysis on the received signals to obtain noise signal data.

The wireless network system for measuring signal noises in accordance with a preferred embodiment of the present invention further includes an output module 12 for outputting noise signal data to devices such as display devices and/or printers. With the output of noise signal data via the output module 12, the operator will then be able to analyze and judge the effect of noise signals.

Referring to FIG. 5, a block diagram of the system for measuring noise signals according to a preferred embodiment of the present invention is illustrated. In the present embodiment, a notebook 20 is a data processing device having the wireless network communications function. The wireless LAN device built into the notebook 20 is a wireless LAN card 22 having an antenna 21. The notebook 20 then uses wireless LAN card 22 for connecting to wireless network such as WLAN via a wireless network base station (not shown in the drawing). The notebook 20 includes at least a computer controller 23 and a display 24. In particular, the computer controller 23 includes a central processing unit, a motherboard, an interface card, a memory and devices (not shown in the drawing) for controlling input and output signals of all computers. The computer controller 23 further has a wireless LAN card driver 25 driving wireless LAN card 22, and includes at least channel configuration function, receiving range configuration function and data processing function.

When the operators combine the notebook 20 with the wireless LAN card 22 for testing, they may find that the data rate and the stability of the wireless LAN card 22 are affected by signal noise due to the antenna 21. The aforementioned situation is probably due to the signal noise interference in the device of the notebook 20 or external noise signal interference. Usually, the problems that the engineers must solve come from the noise signal interference of the notebook 20 and/or wireless LAN card 22. In order to find out and solve the problems so as to modify the product noise signal measurement must be carried out beforehand.

In the present embodiment, the operators load the wireless LAN card driver 25 into the notebook 20, thereby using the channel configuration function in the wireless LAN card driver to configure the receiving channels of the wireless LAN card 22 (e.g. channel 1 of IEEE 802.11b/g, 2412 MHz). Subsequently, the range of the receiving signal strength for the wireless LAN card 22 is enlarged to the maximum. When the noise signals are received, the wireless LAN card driver 25 is executed by the notebook 20, thereby performing data sampling and/or data analysis on signals received by the signal receiving module 10, wherein the received signals include the WLAN signals for data transmission and the noise signals. The way for data sampling and data analysis includes arranging the specific number of noise signal data in a sequence with an increasing order, eliminating a portion of noise signal data from either the beginning or the end of the sequence, and calculating the average of the remaining noise signal data. Therefore, the error of the noise signal data is reduced. The obtained noise signal data will be shown on the display 24. The operators, after obtaining the signal noise data, will immediately perform product analysis and improvement.

In a preferred embodiment, after testing of a specific channel is completed, the wireless LAN card driver 25 will shift to the next channel for noise signal measurement until noise signals on all channels are measured.

Hence, in the present invention, the operators do not have to use expensive and complicated noise signal measuring device to perform noise signal measurement of the system. Noise signal data can be quickly and conveniently obtained by just using data processing device with the installed wireless network device and its driver in the present invention.

The method and system for measuring noise signals in the present invention have the following effects:

(1) fast measurement of the noise signal data for speeding up the research progress during the verification phase and also speeding up the report of the noise signal measurement on the client side. Especially, the client usually does not have professional knowledge of noise signal measurement, and thus the present invention allows the client to obtain noise signal data without additional testing equipments. After reporting back to the manufacturers, the maintenance technicians can then quickly gain the control and speed up the technical support service.

(2) reduction of the cost in research and development. The manufacturers require professional noise signal measuring equipment for product development, however, not all departments or even everyone require measuring equipment. Under certain circumstances when only less precise signal noise data are required, the present invention will significantly lower the R&D cost in certain manufacturers.

(3) Convenience. Operators and clients can perform noise signal measurement anytime at any place just by bringing products (laptop or cell phone) with wireless network receiving device, and thus the present invention provides an extreme high convenience.

In summary, the method and system for measuring noise signals according to the present invention quickly measure the noise signal data, and are highly convenient, thereby reducing the R&D cost of the manufacturers. Hence, a product integrated with wireless network is highly competitive and of a high commercial value.

The foregoing embodiments and advantages are merely exemplary and are not to be construed as limiting the present invention. It will be understood that variations and modifications can be effected thereto by those skilled in the art without departing from the spirit and scope of the invention as defined by the appended claims.

What is claimed is:

1. A method for measuring a noise signal applicable to a data processing device connected to a wireless network system, comprising steps of:
configuring a receiving band of a wireless network signal receiving device;
enlarging a receiving range of the wireless network signal receiving device to the maximum;
receiving signals having wireless network signals for data transmission and noise signals by the wireless network signal receiving device; and
sampling and/or analyzing the signals to obtain noise signal data.

2. The method of claim 1, wherein the step of receiving signals further comprises outputting the noise signal data to a display device.

3. The method of claim 1, wherein the display device is one of a display and a printer.

4. The method of claim 1, wherein the receiving band comprises a plurality channels and the step of sampling and/or analyzing the signals is followed by a step of:
shifting from a channel, at which the receiving is performed, to a next channel, and returning to the step of enlarging the receiving range.

5. The method of claim 1, wherein sampling the signals is performed at a specific sampling rate to obtain a specific number of noise signal data.

6. The method of claim 5, wherein the step of sampling and/or analyzing the signals comprises calculating an average of the specific number of the noise signal data.

7. The method of claim 5, wherein the step of sampling and/or analyzing the signals comprises steps of:
arranging the specific number of the noise signal data in a sequence based on values thereof;
eliminating a portion of the noise signal data from beginning and/or end of the sequence; and
calculating an average of remaining noise signal data.

8. The method of claim 1, wherein the wireless network signal receiving device is a wireless LAN card and/or antenna.

9. The method of claim 1, wherein the wireless network system is one selected from the group consisting of wireless LAN (WLAN), Bluetooth wireless transmission system, global system for mobile communications, integrated packet wireless service system and WiMAX.

10. A system for measuring a noise signal, comprising:
a signal receiving module for receiving signals having wireless network signals for data transmission and noise signals; and
a data processing device for controlling an operation of the signal receiving module, wherein the data processing device comprises:
a channel configuration unit for configuring a receiving band of the signal receiving module;
a receiving range configuration unit for configuring a receiving range of the signal receiving module; and
a data processing unit for performing data sampling and/or data analysis on the signals received by the signal receiving module to obtain noise signal data,
wherein the receiving range of the signal receiving module is enlarged to the maximum by the receiving range configuration unit enlarges.

11. The system of claim 10, wherein the receiving range configuration unit configures a receiving signal strength for the signal receiving module.

12. The system of claim 10, further comprising an output module for outputting noise signal data.

13. The system of claim 12, wherein the output module is one of a display and a printer.

14. The system of claim 10, wherein the data processing unit is a baseband processor.

15. The system of claim 10, wherein the signal receiving module is wireless LAN card, antenna, and/or RF transceiver.

16. The system of claim 10, wherein the data processing device is one of personal computer, notebook, server, workstation, cell phone and PDA.
